(19) United States
(12) Patent Application Publication
(10) Pub. No.: US 2025/0324984 A1
(43) Pub. Date: Oct. 23, 2025

(54) SYSTEMS AND METHODS FOR PORTIONING DOUGHS AND SIMILAR VISCOUS MIXTURES

(71) Applicant: WhitStar Innovations LLC, Lebanon, NH (US)

(72) Inventor: Casey W. Boardman, Lebanon, NH (US)

(73) Assignee: WhitStar Innovations LLC, Lebanon, NH (US)

(21) Appl. No.: 19/172,970

(22) Filed: Apr. 8, 2025

Related U.S. Application Data
(60) Provisional application No. 63/635,736, filed on Apr. 18, 2024.

(51) Int. Cl. A21C 3/10; A21C 3/04; A21C 11/10

(52) U.S. Cl. CPC A21C 3/10; A21C 3/04; A21C 11/10

(57) ABSTRACT

Systems and methods are disclosed herein for portioning of a dough or other viscous mixture in consistent, uniform portion sizes. A dough or other viscous mixture is loaded into a vat from which the dough or other viscous mixture is then extruded as a bar to a receiver assembly, then transferred to a working surface. A portioner can then be applied to the extruded bar of dough or other viscous mixture to divide the bar into a plurality of identical or nearly identical portions. The portioner employs a plurality of cutter assemblies adjustably disposed along a rod to ensure uniform portion sizing.

### RELATED APPLICATIONS

This application claims benefit of priority under 35 U.S.C. § 119(e) of U.S. Provisional Application No. 63/635,736 filed Apr. 18, 2024, which is hereby incorporated herein by reference in its entirety.

### TECHNICAL FIELD

The present disclosure is directed to food preparation, and, more particularly, to portioning doughs and other viscous compounds or mixtures in preparation for baking or cooking, etc.

### BACKGROUND

Food preparation often entails combining a plurality of ingredients into a dough or viscous mixture which then must be portioned prior to baking (or otherwise cooking). In an industrial, high-capacity production environment, a variety of equipment exists for this purpose. In a small, neighborhood market or bakery, or even in a home setting, portioning of doughs and/or mixtures is still pursued by hand. Industrial-capacity equipment is prohibitively expensive, large, and difficult to maintain in the context of the neighborhood market or bakery, let alone in a home kitchen. In recent years, neighborhood bakeries have made a resurgence, in particular, in the form of local cookie bakeries. Hand-portioning the quantity of dough for cookies produced in such local bakeries can lead to physical injury (e.g., repetitive stress injury or the arm, hand, or fingers; carpal tunnel syndrome, etc.) and even disability, exposing individual employees to lifelong suffering, and potentially exposing local bakeries to expensive healthcare and/or liability costs. Furthermore, hand-portioning doughs and mixtures is fraught with inaccurate results, leading to higher costs and/or a lower quality (and less consistent) product.

### SUMMARY

The present disclosure is directed to systems and methods for portioning viscous compounds such as dough or other cooking mixtures prior to baking or cooking.

Additional aspects and advantages will be apparent from the following detailed description of preferred embodiments, which proceeds with reference to the accompanying drawings.

### BRIEF DESCRIPTION OF THE DRAWINGS

FIG. 1A is a front view of a dough portioning system, according to an embodiment of the present disclosure.

FIG. 1B is a side view of the dough portioning system of FIG. 1A, according to an embodiment of the present disclosure.

FIG. 1C is a perspective view of the dough portioning system of FIGS. 1A and 1B, according to an embodiment of the present disclosure, with a bar of dough being dispensed (e.g., extruded).

FIG. 1D is a partial perspective view of the dough portioning system of FIGS. 1A-1C, according to an embodiment of the present disclosure, with the receiver tray disengaged from the receiver assembly.

FIG. 2A is a top view of a receiver assembly of a dough portioning system, according to an embodiment of the present disclosure.

FIG. 2B is a front view of the receiver assembly of the dough portioning system of FIG. 2A, according to an embodiment of the present disclosure.

FIG. 2C is a side view of the receiver assembly of the dough portioning system of FIGS. 2A and 2B, according to an embodiment of the present disclosure.

FIG. 3 is a front view of a portioner of a dough portioning system, according to an embodiment of the present disclosure.

FIG. 4A and a FIG. 4B are, respectively, a bottom view and a front view of a portioner of a dough portioning system, according to an embodiment of the present disclosure.

FIGS. 4C-4E are each a side view of an embodiment of a cutter assembly, each of a respective plurality of cutter assemblies of a respective portioner of the dough portioning system of FIGS. 4A and 4B, according to an embodiment of the present disclosure.

FIG. 5A is a front view of a portion of a dough portioning system, according to an embodiment of the present disclosure, and showing the head of the plunger.

FIG. 5B is a front view of a portion of a dough portioning system, according to an embodiment of the present disclosure, and showing the head of the plunger.

FIG. 6 is a front view of part of a dough portioning system, according to an embodiment of the present disclosure, and illustrating extrusion of a bar.

FIG. 7A is a front view of part of a dough portioning system, according to an embodiment of the present disclosure, and showing details of the extrusion port.

FIG. 7B is a front view of a plurality of aperture collars for the dough portioning system of FIG. 7A, according to an embodiment of the present disclosure.

FIG. 8 is a front view of part of a dough portioning system, according to an embodiment of the present disclosure, and showing a mechanism.

FIG. 9 is a method for a dough portioning system, according to an embodiment of the present disclosure.

### DETAILED DESCRIPTION OF PREFERRED EMBODIMENTS

For centuries, production of foods from doughs or viscous mixtures has relied on hand portioning. From the Middle Ages to the latter part of the 20^{th} century, even commercial bakeries relied on workers' hands to individually portion each loaf, pie, cookie, pastry, etc. Thereafter, large commercial interests could afford the cost of equipment (and maintenance, plus the space requirements) that more reliably portioned the doughs or mixtures while increasing productivity and holding down costs. Such an advantage has yet to make its way to smaller, less industrialized bakeries, markets, or the home. Neighborhood bakeries from the 19^{th} century to today still rely on the hands of employees to individually portion doughs and mixtures. Conditions surrounding or devolving from the Great Depression, World War I, and World War II adversely affected neighborhood bakeries and in-home baking and cooking. In recent years, neighborhood bakeries, and at-home baking and cooking, has seen particular growth. In particular, tremendous growth is now occurring in the context of local cookie bakeries offering specialty cookies, cakes, pastries, etc. At the same time, holiday cooking and baking is on an upswing.

There is, at present, no method or system of reliably and repetitively (to the degree of these cookie bakeries, and holiday home baking) producing portions of dough or similar mixtures other than by hand. Such hand-portioning is either error-prone or time-consuming, or both. This produces inefficiencies that are evidenced in increased costs, lower quality goods, and inconsistent product. Hand-portioning at scales seen in such cookie bakeries, as well as during holiday seasonal home baking, can result in injury, such as e.g., carpal tunnel syndrome, lateral epicondylitis (e.g., tennis elbow), and/or other repetitive stress injury to arm, hand, fingers, etc., nerve damage, etc. Industrial-capacity equipment does not address these issues, as such equipment is expensive to acquire, costly to maintain, inefficient at low levels of production, energy-intensive to operate, large, and noisy (giving rise to additional health considerations). The present invention provides systems and methods that enable accurate, repetitive, reliable portioning of doughs and viscous mixtures or compounds in the context of a neighborhood bakery, a cookie bakery, a home kitchen (in particular during holiday baking seasons), etc., thereby reducing costs, increasing efficiency, and avoiding injury.

The following description describes embodiments of the present disclosure with primary reference to systems and methods of portioning doughs or other viscous mixtures or compounds.

As used herein, the terms “couple,” “coupled,” and “coupling” indicate the placement or positioning of two or more items or components in proximity to each other, and may include, for example, physical connection of the items or components, mechanical connection (e.g., bolted together, etc.), locational proximity (e.g., placed adjacent each other, etc.), etc. To be coupled, it is not necessary that items be fixedly connected together. Furthermore, two or more items or components may be coupled together by means of or across an intervening or interposed item or component (e.g., a bracket, a washer, a brace, etc.).

As used herein, the term “dough” has the ordinary meaning of the word in the art of baking and food preparation.

As used herein, the terms “viscous mixture,” “mixture,” and “compound” refer generally to a viscous material having a resistance to flow similar to that of a dough.

As used herein, the term “size” refers to either dimensions, such as, e.g., length, width, height, thickness, etc., or mass, or both.

As used herein, the term “portion size” refers to a size of a portion of dough or viscous mixture.

As used herein, the term “like size” refers to a plurality of portions of similar size, wherein similar size is intended to represent identicality or near-identicality.

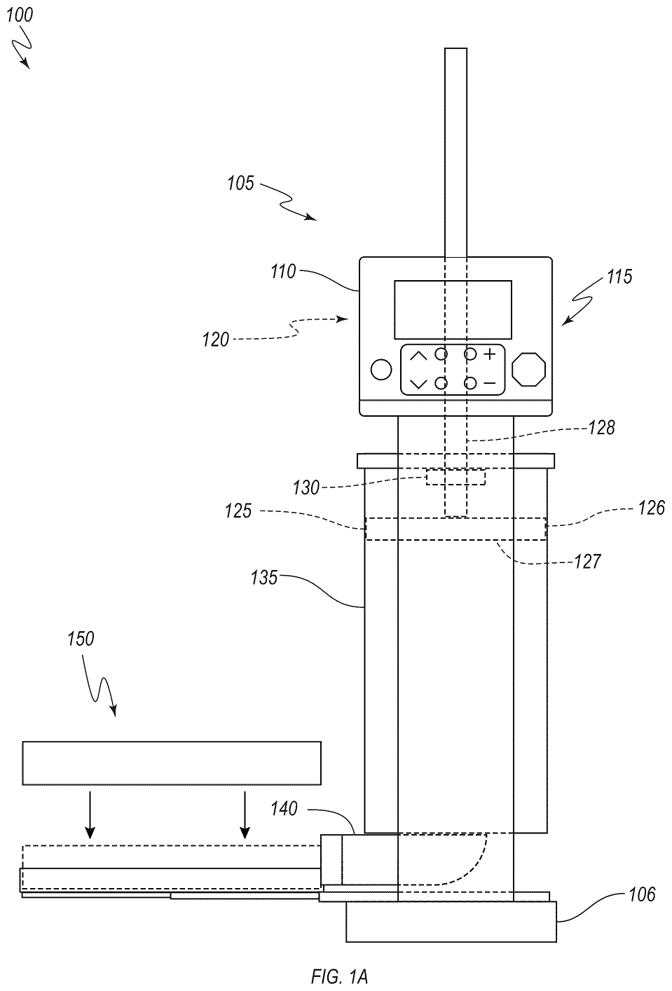

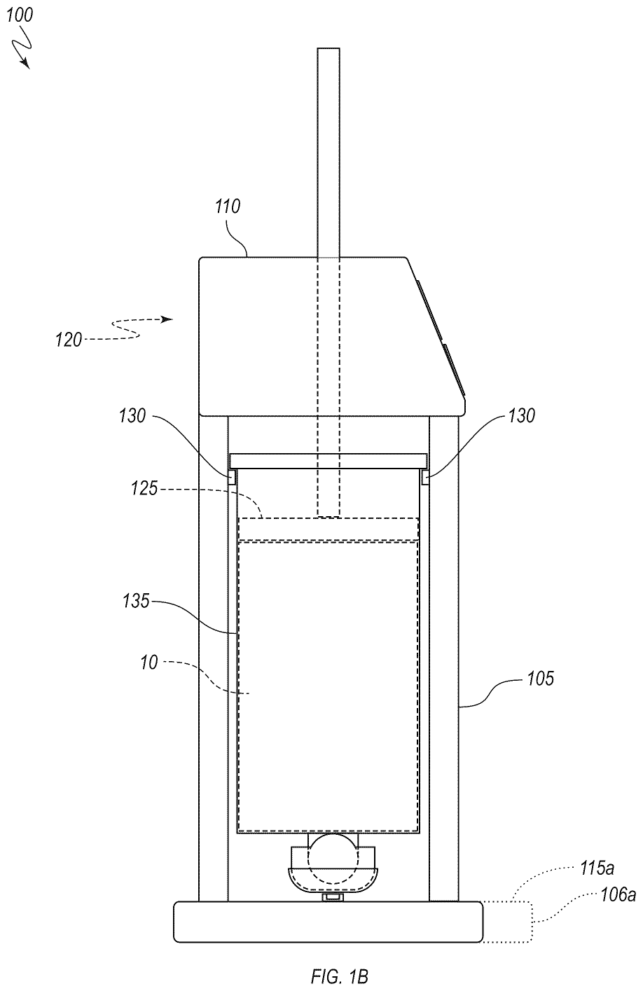

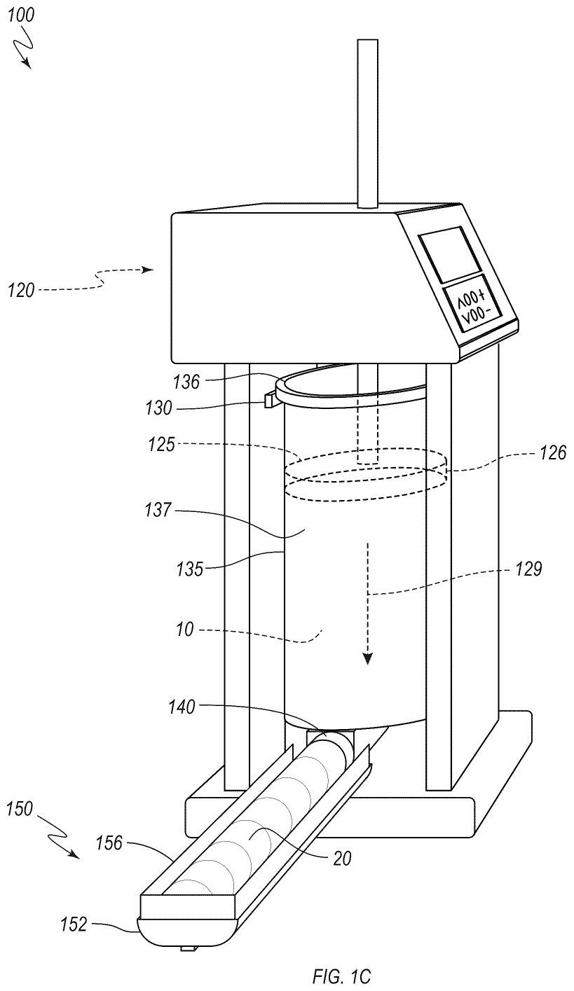

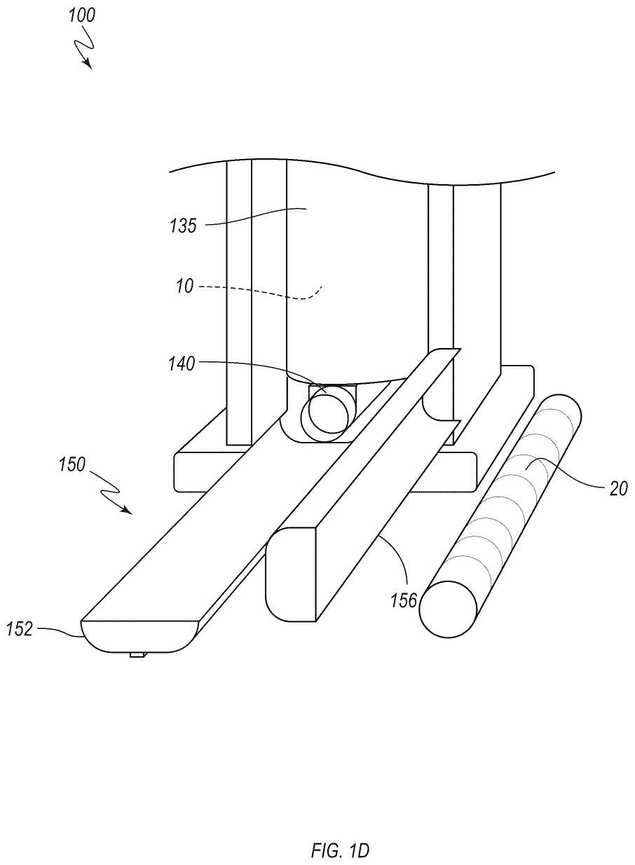

FIG. 1A is a front view of a dough portioning system 100, according to an embodiment of the present disclosure. The dough portioning system 100 is a system to portion a viscous mixture or other material. While the present embodiment is described with reference to a “dough,” the disclosure anticipates that the portioning system may be similarly used with any of a variety of viscous mixtures or compounds (potentially including non-food viscous mixtures, compounds, emulsions, and the like). The dough portioning system 100 comprises a superstructure 105 and a base 106. A motor housing 110 may be coupled to the superstructure 105. The superstructure 105 can receive, engage, or otherwise support a vat 135 (or hopper) to receive, contain, or otherwise hold a dough or a viscous mixture to be portioned. The vat 135 may be formed of stainless steel, rigid plastic, or other rigid material suitable for providing a food grade container (designed and/or certified to safely store and/or transport food, ensuring no harmful substances leach into the food and that the container itself is safe for food contact). The vat 135 may have a cylindrical shape, with an open top and a sidewall to form the cylindrical shape. A bottom of the vat 135 may taper to an extrusion port 140 or other opening for dispensing the dough or viscous mixture.

The dough portioning system 100 can comprise a control panel 115. The control panel 115 may be coupled to the motor housing 110. The control panel 115 may allow configuring the dough portioning system 100 for a particular dough or viscous mixture, such as, e.g., setting an extrusion (or dispense) rate. The motor housing 110 may house at least a portion of a plunger motor 120, the plunger motor 120 is configurable to drive a plunger 125, for example to extrude or otherwise dispense the dough or viscous mixture. The plunger motor 120 provides a force (e.g., an input force) to drive a plunger 125 to supply a compressive force on the dough. In the embodiment of FIG. 1A, the plunger 125 includes a shaft 128, a head 126, and a dough engagement surface 127. The plunger head 126 may be formed of steel, plastic, or any other suitable rigid material to supply a compressive force on the dough. The dough portioning system 100 further comprises a vat support 130 to accept and support a vat 135. The vat support 130 may take any appropriate form, such as, e.g., a dimple-and-recess, a post-and-hole (potentially spring-loaded), a toggle-lift, etc. The dough portioning system 100 also comprises an extrusion port 140 (or similar dispense port) and a receiver assembly 150.

The control panel 115 may be configured with a user interface. The user interface may be configured to accept input whereby the dough portioning system 100, and more particularly, the plunger motor 120 can be configured to cause extrusion via the extrusion port 140 in a particular manner. In one embodiment, the control panel 115 may comprise a plurality of buttons or switches (or both) articulable by a user to provide input for configuring the dough portioning system 100. For example, the buttons and/or switches may enable incrementally selecting a viscosity of the dough or mixture, a rate of extrusion, resetting the dough portioning system 100 to facilitate reloading the vat, etc. In one embodiment, the user interface may comprise a visual touch screen configured to display options for configuring the dough portioning system 100. The displayable options may, for example, display a name for each dough or viscous mixture which, when selected by a user, provides the dough portioning system 100 with configuration data relative to the selected dough or viscous mixture. Other types of user interfaces are envisioned by the present disclosure. Furthermore, in various embodiments, the dough portioning system 100 may be controlled by operation of a foot pedal, a hand pedal, a remote switch, an application installed to a computing device (the computing device electrically coupled with the dough portioning system 100), etc.

FIG. 1B is a side view of the dough portioning system 100 of FIG. 1A, according to an embodiment of the present disclosure. The superstructure 105, the control panel 115, the motor housing 110, the plunger motor 120, the vat support 130, and the vat 135 are shown for reference. The vat 135 is depicted containing dough 10. A plunger 125 is coupled with the plunger motor 120 whereby the plunger motor 120 is able to drive the plunger 125 downward and upward. The control panel 115 may be used to configure the plunger motor 120 to drive the plunger 125 downward at an appropriate rate for dough or viscous mixture (hereafter, dough) 10 contained within the vat 135 and disposed below the plunger 125. The control panel 115 may enable signaling the plunger motor 120 to lift the plunger 125, including to lift the plunger 125 above the vat 135 to permit removal of the vat 135 from the superstructure 105.

In some embodiments, the plunger 125 may be a piston or a press. In some embodiments, an impeller may be utilized in place of the plunger 125. In some embodiments, such an impeller may be a screw impeller.

In some embodiments, the plunger 125 may feed dough to a separate impeller that pumps the dough to an extrusion port or similar dispense port.

In some embodiments, the control panel 115a (or some controls of the control panel (see the control panel 115 in FIG. 1A) may be disposed at a widened or extended base 106a.

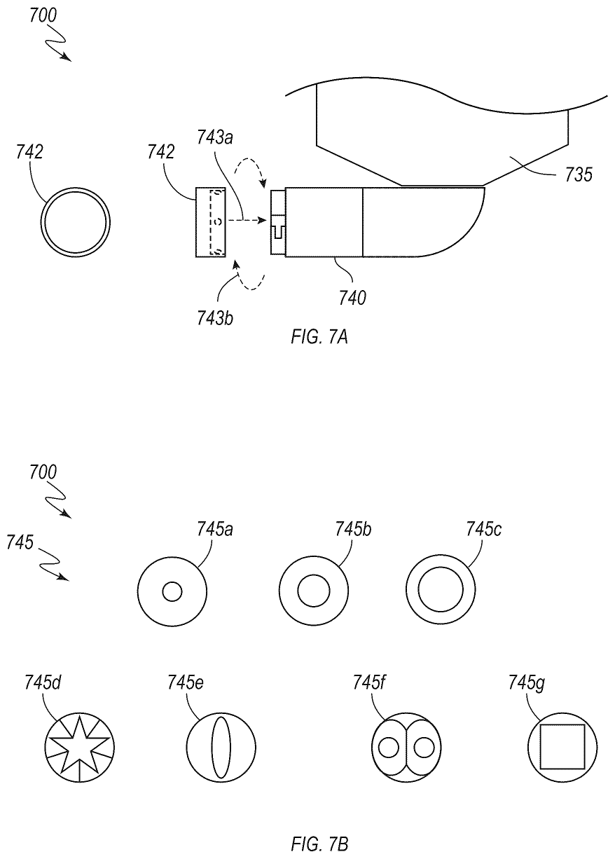

FIG. 1C is a perspective view of the dough portioning system 100 of FIGS. 1A and 1B, according to an embodiment of the present disclosure, with a bar 20 of dough 10 (also sometimes referred to as a dough log) being dispensed (e.g., extruded). The vat support 130 and vat 135 are identified for reference. The vat 135 may have an open top 136 to facilitate loading dough 10 into the vat 135 and to accommodate the plunger 125. The vat 135 has a sidewall 137 to contain the dough 10. An extrusion port 140 is disposed at or near a portion of the vat 135 distal to the plunger motor 120. The extrusion port 140 is configured to allow extrusion of the bar 20 or otherwise dispense the bar 20 from the vat 135, by action of the plunger 125 being driven by the plunger motor 120 to create a compressive force 129. The extrusion port 140 extrudes, delivers, or otherwise provides the bar 20 to the receiver assembly 150. The extrusion port 140 may be configured to have a particular diameter, shape, etc. (as further discussed in conjunction with FIGS. 7A and 7B). The receiver assembly 150 comprises a receiver carriage 152 and a receiver tray 156. The receiver tray 156 is configured to receive the bar 20 from the extrusion port 140.

FIG. 1D is a partial perspective view of the dough portioning system 100 of FIGS. 1A-1C, according to an embodiment of the present disclosure, with the receiver tray 156 disengaged from the receiver assembly 150. The vat 135 and extrusion port 140 are shown for reference. The receiver carriage 152 is in an extended position at the receiver assembly 150. The receiver tray 156 is detached from the receiver assembly 150 to facilitate depositing or otherwise disposing the now-separated bar 20 to a work surface.

It should be noted that, in one embodiment, the dough portioning system 100 may be configured to automatically drive the plunger upward sufficiently to stop extrusion of dough 10 from the extrusion port 140 (see the plunger 125 in FIGS. 1B and 1C).

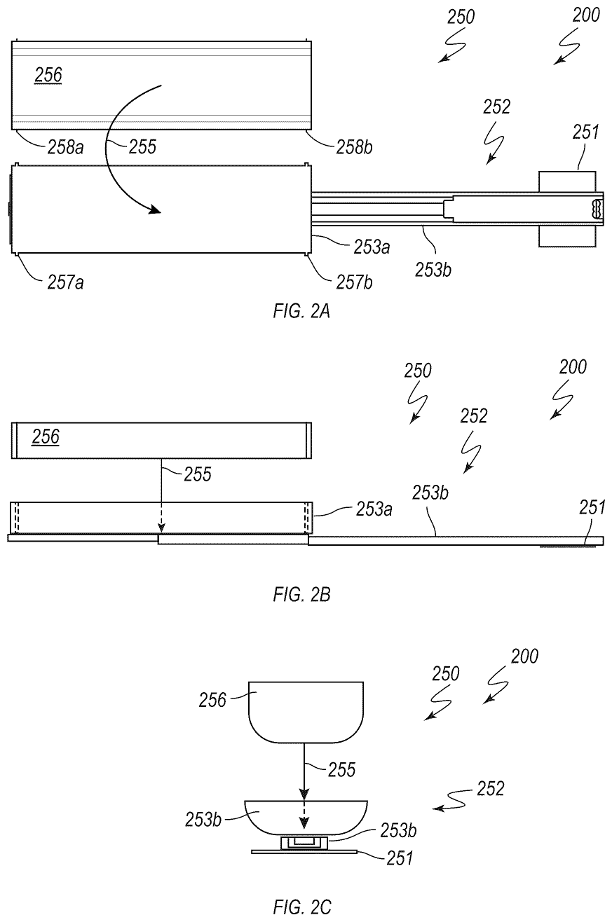

FIG. 2A is a top view of a receiver assembly 250 of a dough portioning system 200, according to an embodiment of the present disclosure. The dough portioning system 200 may be similar in at least some respects to the dough portioning system 100 of FIGS. 1A-1D. The receiver assembly 250 comprises a mounting plate (or base) 251, a receiver carriage 252 (including a cradle 253a and an slide 253b), and a receiver tray 256. The mounting plate 251 may facilitate coupling the receiver assembly 250 to the dough portioning system 200. The extension slide 253b is configured to permit the receiver carriage 252 to move laterally away from and toward the extrusion port (see the extrusion port 140 in FIGS. 1C and 1D). In one embodiment, the extension slide 253b includes a roller bearing slide. In one embodiment the extension slide 253b includes a ball-bearing slide. In one embodiment, the extension slide 253b includes a key-on-keyway slide.

The receiver tray 256 may be placed 255 onto the receiver carriage 252 in preparation for receiving a bar of dough or viscous mixture (see the bar 20 in FIGS. 1C and 1D). The receiver tray 256 may be detachable from the receiver carriage 252 to facilitate disposing the bar 20 to a working surface, as well as for cleaning.

The receiver carriage 252 includes a cradle 253a coupled to a slide 253b. The cradle 253a may be equipped with a first tray guide 257 (257a, 257b) to facilitate placement of the receiver tray 256. The receiver tray 256 may be equipped with a second tray guide 258 (258a, 258b) corresponding to the first tray guide 257 such that the first and second tray guides 257a, 258a; 257b, 258b align and couple the receiver tray 256 to the cradle 253a. With the tray guides 257, 258 (257a, 258a; and 257b, 258b) coupled, the receiver carriage 252 is configured such that the receiver tray 256 can receive a bar of dough as it is extruded from the extrusion port. As the extrusion continues, the receiver tray 256 is displaced away from the extrusion port, and the tray guides 257, 258 cause the cradle 253a to traverse with the movement of the receiver tray 256, ensuring the receiver tray 256 is supported by the slide 253b. In one embodiment, the tray guides 257, 258 may be, or may include magnets.

The slide 253b may be or include any suitable mechanism for translating or otherwise enabling the receiver carriage 256 to move (or be displaced by the dough log) relative to the vat. In one embodiment, the slide 253b can include a roller-bearing slide. In one embodiment, the slide 253b can include a ball-bearing slide. In one embodiment, the slide 253b can include a key-on-keyway slide (e.g., sliding dovetail guide).

FIG. 2B is a front view of the receiver assembly 250 of the dough portioning system 200 of FIG. 2A, according to an embodiment of the present disclosure. The mounting plate 251, the receiver carriage 252 (including the cradle 253a, the slide 253b), and the receiver tray 256 are shown for reference. The receiver tray 256 is configured to be placed 255 on or in the cradle 253a.

FIG. 2C is a side view of the receiver assembly 250 of the dough portioning system 200 of FIGS. 2A and 2B, according to an embodiment of the present disclosure. The mounting plate 251, the cradle 253a and slide 253b of the receiver carriage 252, and the receiver tray 256 are shown for reference. The receiver tray 256 is configured to be placed 255 in/on the cradle 253a.

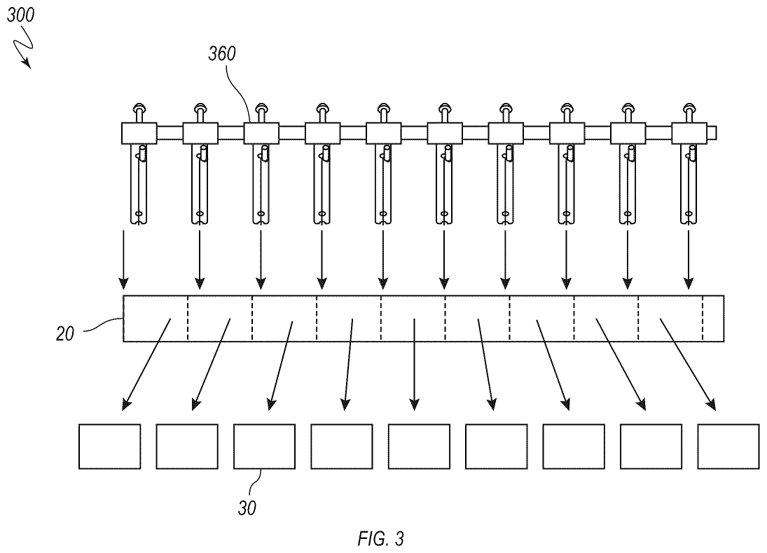

FIG. 3 is a front view of a portioner 360 of a dough portioning system 300, according to an embodiment of the present disclosure. The dough portioning system 300 may be similar in at least some respects to the dough portioning systems 100, 200 of FIGS. 1A-2C. As depicted in FIG. 3, a bar 20 of dough has been extruded via the extrusion port and has been turned out from a receiver tray (see the extrusion port 140 and receiver tray 156 in FIG. 1D). The portioner 360 is disposed over the bar 20 preparatory to manipulating the portioner 360, for example, by pushing the portioner 360 through the bar 20. Pushing the portioner 360 into/through the bar 20 divides the bar into a plurality of like size portions 30. Dividing the bar 20 into a plurality of like size portions 30 by means of the portioner 360 may provide uniformity in portion 30 size and, ergo, uniformity in final product; and may reduce the time needed to produce a plurality of final products; may reduce a risk of injury to a person using the dough portioning system 300 as compared to not using a dough portioning system; and may reduce overall cost of operation for the business using the dough portioning system 300.

In one embodiment, the portioner 360 may be articulably attached to the dough portioning system 300, such as adjacent the extrusion port (see the extrusion port 140 in FIG. 1A). In one embodiment, the portioner 360 may be detached from the dough portioning system 300, and may be usable independently from the remainder of the dough portioning system 300.

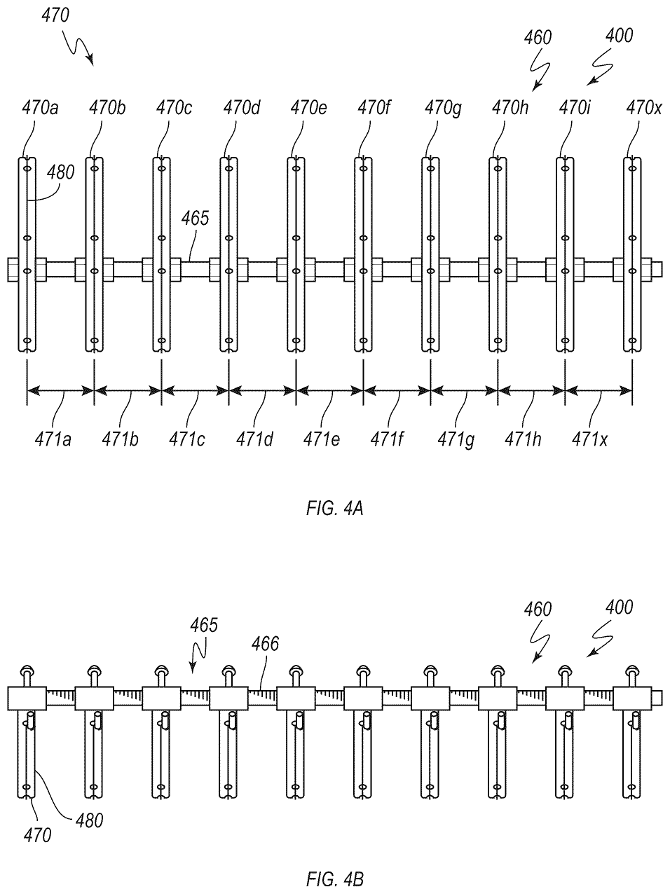

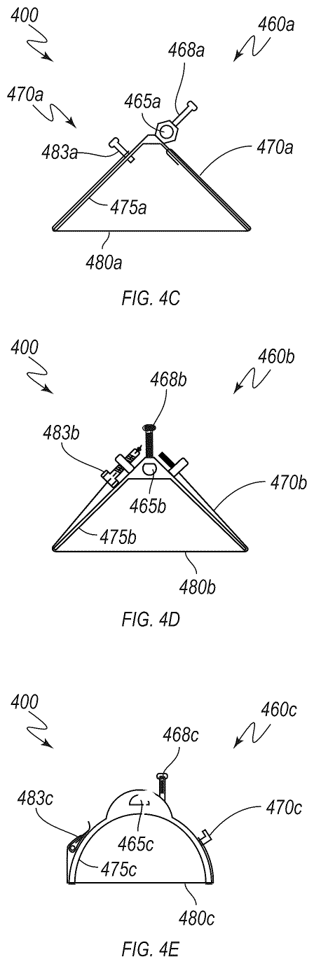

FIG. 4A and FIG. 4B are, respectively, a bottom view and a front view of a portioner 460 of a dough portioning system 400, according to an embodiment of the present disclosure. The dough portioning system 400 may be similar in at least some respects to the dough portioning systems 100, 200, 300 of FIGS. 1A-3. The portioner 460 includes a rod 465 and a plurality of cutter assemblies 470 disposed at uniform distances 471a-471x along the rod 465. The rod may have a cross-section to provide rigidity and/or engagement of the plurality of cutter assemblies 470. For example, the cross-section of the rod may be circular, elliptical, square, D-shaped, hexagonal, or any other appropriate shape. Each cutter assembly 470a-470x of the plurality of cutter assemblies 470 has a cutter 480.

Each cutter assembly 470a-470x is uniformly spaced (471a-471x) from each adjacent cutter assembly 470a-470x along the rod 465. With the cutter assemblies 470a-470x uniformly spaced along the rod 465, the portioner 460 is configured to form like size portions when the portioner is articulated through the bar 20. Articulating the portioner 460 causes the cutter 480 of each cutter assembly 470a-470x of the plurality of cutter assemblies 470 to be simultaneously pushed through the bar 20 to produce (e.g., cut, divide, separate) a plurality of portions 30 of uniform or near uniform size.

To facilitate uniform spacing of the cutter assemblies 470a-470x, the rod 465 may include a spacing gauge 466. The spacing gauge 466 may permit manually spacing the cutter assemblies 470a-470x. In one embodiment, the portioner 460 may include a polyhelical adjustment mechanism (e.g., a 8-bar linkage) that, when operated, moves each of the cutter assemblies 470a-470x simultaneously and graduatedly to maintain equal spacing while adjusting for a different size portion.

FIGS. 4C-4E are each a side view of an embodiment of a cutter assembly 470a, 470b, 470c, each of a particular embodiment of a portioner 460a, 460b, 460c of the dough portioning system 400 of FIGS. 4A and 4B, according to an embodiment of the present disclosure. For each portioner 460a, 460b, 460c, each cutter assembly associated with the particular portioner 460a, 460b, 460c is essentially identical to the respective depicted cutter assembly 470a, 470b, 470c. In FIG. 4C, the cutter assembly 470a has a rod lock screw 468a, spanner 475a, a cutter 480a, and a tensioner 483a. The rod lock screw 468a may be configured to adjustably position each cutter assembly 470a along the rod 465a. The spanner 475a forms a frame for the cutter 480a, the spanner 475a configured to support the cutter 480a as the cutter 480a passes through a bar of dough or other viscous mixture, while avoiding contact with the bar or other viscous mixture (see the bar 20 in FIGS. 3A and 3B). In the embodiment of FIG. 4C, the cutter 480a is (or has) a food-grade wire that is tensioned using the tensioner 483a. In one embodiment, the spanner 475a may be sprung, or spring-loaded, to impose tension on the cutter 480a. In one embodiment, the cutter 480a, rather than being a food-grade wire, may be or have a replaceable food-grade plastic or metallic blade supported by the spanner 475a. In one embodiment, the cutter 480a may be a pre-tensioned wire (e.g., factory tensioned).

In FIG. 4D, the portioner 460b includes a rod 465b that is indexed, keyed, or otherwise configured with a particular alignment shape whereby the cutter assembly 470b is adjustably fixed to the rod 465b. The lock screw 468b may be configured to engage the index, key, or other alignment shape of the rod 465b to maintain alignment to, and position along the rod 465b. The cutter assembly 470b also has a spanner 475b, a cutter 480b, and a tensioner 483b that may be similar in pertinent respects to the spanner 475a, cutter 480a, and tensioner, 483a of FIG. 4C.

In FIG. 4E, the portioner 460c includes a rod 465c that is semi-circular or approximately semi-circular in profile whereby the cutter assembly 470c is adjustably fixed to the rod 465c. The lock screw 468c may be configured to engage a portion of the rod 465c to maintain an alignment and position of the cutter assembly 470c relative to the rod 465c. The cutter assembly 470c has a spanner 475c, a cutter 480c, and a tensioner 483c. In the embodiment of FIG. 4E, the spanner 475c is illustrated having a curvilinear profile. The curvilinear profile of 475c may be employed in another embodiment, such as with the spanners 475a and 475b of, respectively, FIGS. 4C and 4D. The tensioner 483c provides a means of adjustably tensioning the cutter 480c. The tensioner 483c is shown in the form of a spring clip, which may, likewise, be employed with another embodiment. Further exchange of the components and subcomponents of the dough portioning system 400 from one embodiment to another is anticipated by the present disclosure. The disclosure anticipates other embodiments of the cutter assemblies 470a, 470b, 470c and depiction of these three embodiments is for convenience of the disclosure and not by way of limitation.

The cutter assembly 470a, 470b, 470c is configured to be repositionable along the respective rod 465a, 465b, 465c, as well as being removable and replaceable. While a lock screw 468a, 468b, 468c is illustrated, this is for convenience of the disclosure only and other means of adjustably fixing the cutter assembly 470a, 470b, 470c to the rod 465a, 465b, 465c are anticipated by the disclosure, such as, e.g., a spring clip, a push pin, a toggle, etc. As previously noted, the cutter 480a, 480b, 480c may take the form of a food grade wire, a food grade metallic blade, a food grade plastic blade, or any other suitable material. The tensioner 483a, 483b, 483c may be a screw, a spring clip, or other suitable feature. In one embodiment, tensioning may be accomplished in conjunction with manufacture of the dough portioning system 400 (e.g., pretensioned during manufacture). The rod 465a, 465b, 465c may have a circular profile, ovoid profile, polygonal profile, combination profile, etc., and may be indexed.

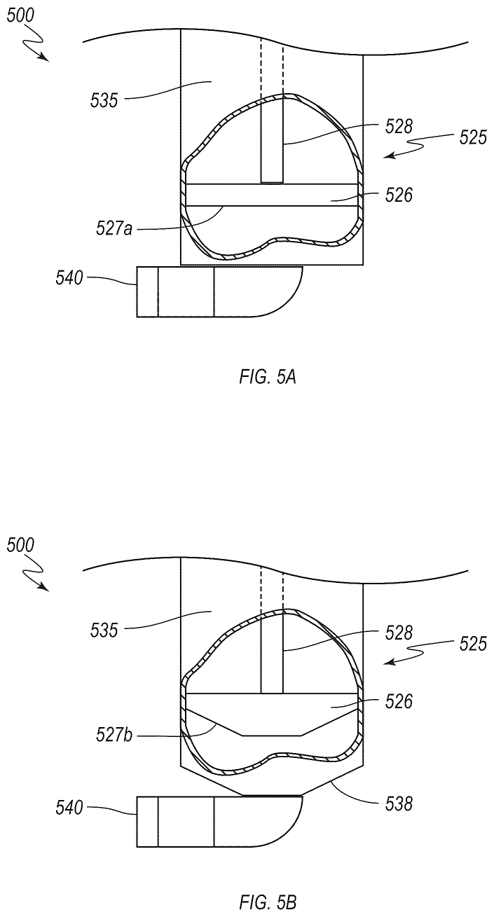

FIG. 5A is a front view of a portion of a dough portioning system 500, according to an embodiment of the present disclosure, and showing the head 526 of the plunger 525. The dough portioning system 500 is similar in at least some respects to the dough portioning systems 100, 200, 300, and 400 of FIGS. 1A-4E. The vat 535 and extrusion port 540 are shown for reference. The vat 535 is partially cut away to show the plunger 525 in more detail. The head 526 of the plunger 525 takes the form of a flat disk (viewed edge-on). A dough engagement surface 527a is disposed downward, or distal to the shaft 528.

FIG. 5B is a front view of a portion of a dough portioning system 500, according to an embodiment of the present disclosure, and showing the head 526 of the plunger 525. The dough portioning system 500 is similar in at least some respects to the dough portioning systems 100, 200, 300, and 400 of FIGS. 1A-4E. The vat 535 and extrusion port 540 are shown for reference. The vat 535 is partially cut away to show the plunger 525 in more detail. The head 526 of the plunger 525 has a conical shape (viewed in profile). The vat 535 has a coordinating conical bottom 538. The dough engagement surface 527b is conical.

The plunger 525 of FIGS. 5A and 5B may be removable to facilitate cleaning, (re)loading the vat 535, etc. The head 526 may be removable to facilitate cleaning, (re)loading the vat 535, replacement of a worn head 526, or use of head 526 having a different profile. The shaft 528 may be formed of any appropriate material, such as, e.g., stainless steel, plastic, etc. The head 526 may be formed of any appropriate material, such as, e.g., stainless steel, plastic, etc. In one embodiment, the shaft 528 and the head 526 are unitary (i.e., not detachable from the plunger 525).

In one embodiment, the connection mechanism for attaching the plunger 525 to the shaft 528 can be a shaft-insertion system with a locking pin. The plunger 525 can include a hub with an opening that slides onto the shaft 528. The plunger 525 can click into place with a pin or notch system and/or a slight rotation. The pin or notch system prevents the plunger 525 from detaching during use. The downward force on the shaft and plunger, and the locking design, maintain the plunger 525 engaged. To detach, simply align the opening and the notch on the plunger 525 with the pin on the shaft 528 and separate the shaft 528 and the plunger 525.

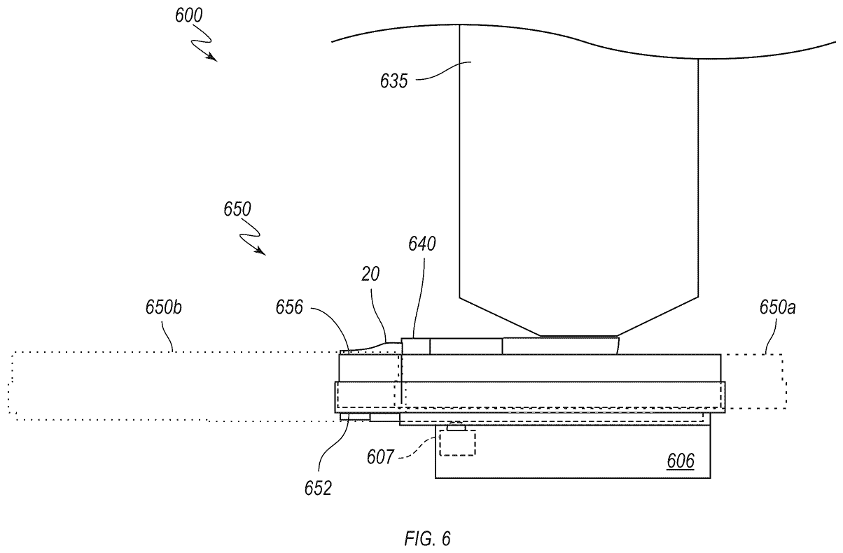

FIG. 6 is a front view of part of a dough portioning system 600, according to an embodiment of the present disclosure, and illustrating extrusion of a bar 20. The bat 635 and the extrusion port 640 are shown for reference. The bar 20 is shown partially extruded and being received into the receiver tray 656. The receiver tray 656 is coupled to the receiver carriage 652. As the bar 20 is further extruded, the receiver tray 656 and receiver carriage 652 translate away from the extrusion port 640 to receive the length of the bar 20. When the bar 20 is extruded (fully, or to a desired length), the receiver tray 656 and receiver carriage 652 are disposed at 650b.

In one embodiment, the dough portioning system 600 includes a limit switch 607. The limit switch 607 may disposed at or in the base 606. When the receiver carriage 652 extends a predetermined distance from the extrusion port 640, the limit switch 607 is activated, whereupon the plunger motor is halted, stopping the downward motion of the plunger and substantially relieving the compressive force that causes extrusion (see plunger motor 120, the plunger 125, and the compressive force 129 in FIG. 1C). In one embodiment, the limit switch 607 may be configured to briefly reverse the plunger motor so that the compressive force is more fully relieved to prevent “overflow” extrusion. In one embodiment, the function of the limit switch 607 may be supplanted by a timing mechanism or means. The timing mechanism or means may be adjustable for a particular dough or viscosity such that the plunger motor operates for a predetermined period of time and is then halted (and may also be momentarily reversed). The process of resetting the receiver carriage 652 may reset the timing mechanism or means. Once the bar 20 is removed from the receiver tray 656, the receiver tray and receiver carriage are returned to a starting position 650a. In one embodiment, receiver tray and receiver carriage are manually moved to the starting position 650a. In one embodiment, the receiver tray and receiver carriage may be electromechanically moved to the starting position 650a. In one embodiment, the limit switch 607, or the timing mechanism or means, may be coupled directly to the plunger whereby the limit switch 607 is activated upon when the plunger has moved a predetermined distance.

FIG. 7A is a front view of part of a dough portioning system 700, according to an embodiment of the present disclosure, and showing details of the extrusion port 740. The dough portioning system 700 is similar in at least some respects to the dough portioning systems 100-600 of FIGS. 1A-6. The extrusion port 740 includes a detachable aperture collar 742. The aperture collar 742 is shown in both a front and a side profile for reference. The aperture collar 742 may be coupled to the extrusion port 740 by sliding 743a on to the extrusion port 740 and rotating 743b to engage a securement feature. The securement feature may take any suitable form for retaining the aperture collar 742 in place, including, e.g., screw-threading, post-and-notch, etc.

FIG. 7B is a front view of a plurality of aperture collars 745 for the dough portioning system 700 of FIG. 7A, according to an embodiment of the present disclosure. As may be appropriate to a particular dough and/or desired end product, the aperture collar 742 of FIG. 7A may be removed and another aperture collar 745a-745x may be employed. The aperture collar 745a may have a significantly smaller extrusion diameter with regard to the aperture collar 742 of FIG. 7A. The aperture collar 745b may have a first intermediate extrusion diameter. The aperture collar 745c may have a second intermediate extrusion diameter. Said otherwise, a plurality of aperture collars 745 may provide a variety of extrusion diameters. The aperture collar 745d may provide a star-shaped extrusion profile. The aperture collar 745e may provide an oval extrusion profile. The aperture collar 745f may provide a double extrusion profile. The aperture collar 745g may provide a square extrusion profile. These are but a few potential aperture collars 745 that may be employed on the dough portioning system 700. The aperture collars 745 shown in FIGS. 7A and 7B are by way of example and not limitation, as the disclosure anticipates aperture collars 745 to provide yet other extrusion profiles.

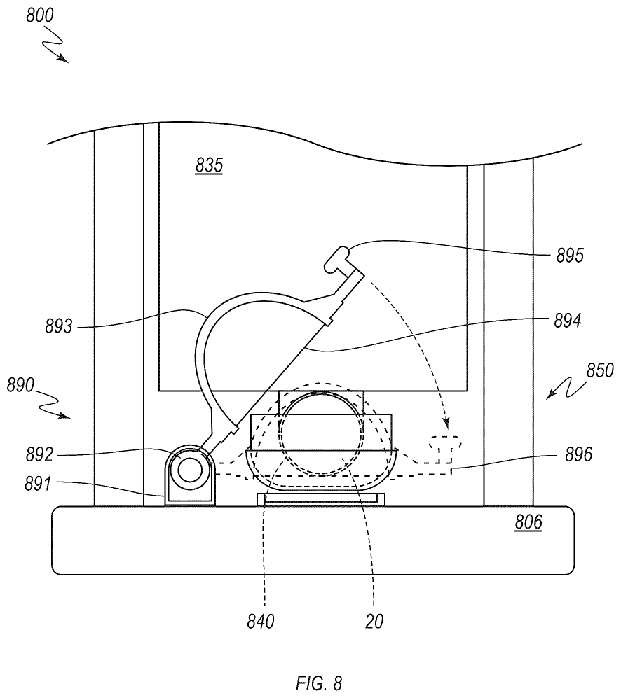

FIG. 8 is a front view of part of a dough portioning system 800, according to an embodiment of the present disclosure, and showing a mechanism 890. The dough portioning system 800 is similar in at least some respects to the dough portioning systems 100-700 of FIGS. 1A-7B. The cutting mechanism 890 is disposed adjacent the extrusion port 840 and is shown in an unarticulated position (start position). The cutting mechanism 890 has a mount 891, a spring housing 892, a frame 893, a cutter 894, and a handle 895. The mount 891 couples the cutting mechanism 890 to the base 806 of the dough portioning system 800. In one embodiment, the cutting mechanism 890 may couple to another feature of the dough portioning system 800, such as, e.g., to a part of the superstructure, to the extrusion port 840, etc. The spring housing 892 may contain a coil spring (or other spring type) that serves to return the articulated cutting mechanism 890 to the start position. The cutter 894 may be a food-grade wire, a food-grade stainless steel blade, a food-grade plastic blade, etc. The cutter 894 may be adjustably tensionable. The cutter 894 may be replaceable. The cutting mechanism 890 is disposed so as to be clear of the extrusion port 840 to permit unimpeded extrusion. The cutting mechanism 890 may be articulated by means of the handle 895 to sever the extruded bar from the dough (or other viscous material) remaining in the vat 835 (see the bar 20 in FIGS. 1C and 6). If the handle 895 released, the spring of the spring housing 892 returns the cutting mechanism to the start position. The handle 895 may also be used to articulate the cutting mechanism 890 back to the starting position. In one embodiment, the cutting mechanism 890 may be operated electromechanically, pneumatically, hydrodynamically, magnetically, etc. By way of non-limiting example, a button, switch, or foot pedal, etc., may be used to cause the cutting mechanism 890 to both articulate and return to the start position.

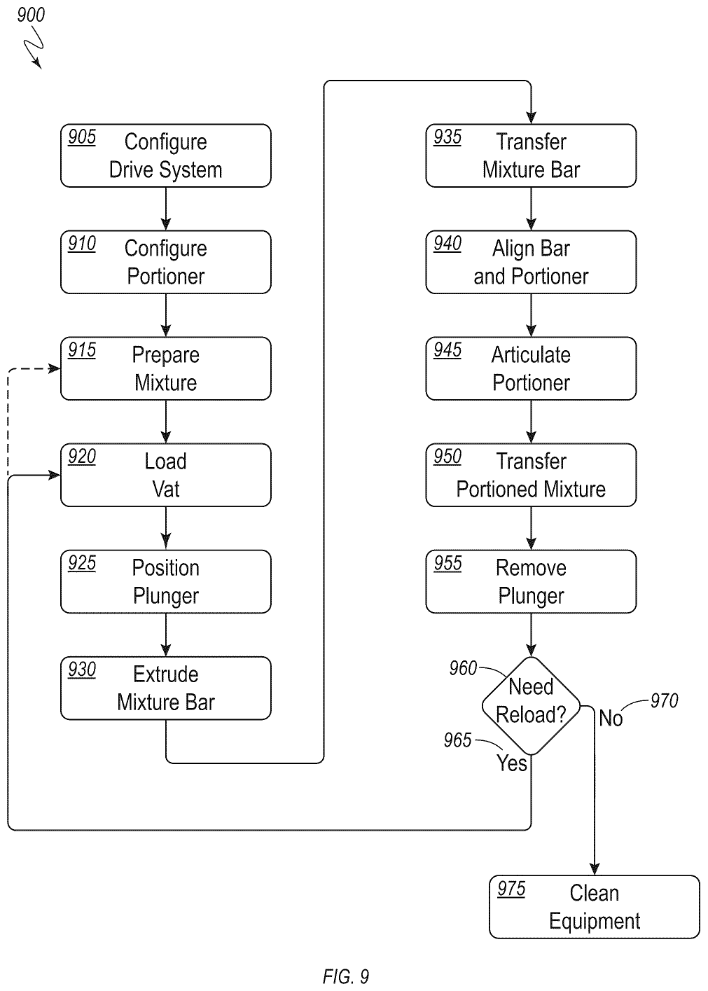

FIG. 9 is a method 900 for a dough portioning system, such as the dough portioning systems 100-800 of FIGS. 1A-8, according to an embodiment of the present disclosure. The method 900 refers to “dough” throughout, however, the disclosure anticipates that another viscous mixture may be portioned with the method 900. The drive system is configured 905. Configuring 905 the drive system may entail one or more of setting a viscosity of the dough to be portioned, selecting a mode (e.g., a manner of operation related to the dough to be portioned), selecting and emplacing an extruder with a particular extrusion port, selecting and attaching a particular receiver assembly, etc. The portioner is configured 910. Configuring 910 the portioner may entail adjusting spacing between each cutter assembly of the portioner, as well as making appropriate adjustments to each cutter assembly (such as, e.g., tensioning the cutter, etc.) The dough is prepared 915. Preparing 915 the dough may entail mixing together a variety of ingredients or components, as by a recipe. While the method 900 calls out an order of configuring 905 the extruder, configuring 910 the portioner, and preparing 915 the dough, this is for convenience of the disclosure only, and these steps may be reordered without altering the effect and result of the method 900. By way of non-limiting example, configuring 905 the drive system may follow any step prior to extruding 930 the dough bar.

The prepared dough is loaded 920 into the vat and the vat is installed to the dough portioning system. The plunger is positioned 925 above the dough in the vat. A dough bar is extruded 930 by activating the drive system, which exerts a compressive force or pressure, by means of the plunger, on the dough in the vat, thereby forcing the dough to extrude 930 through the extrusion port and onto the receiver assembly. The dough bar is transferred 935 from the dough portioning system to a working surface, such as a countertop, a sheet pan, or other appropriate surface. The portioner and the dough bar are aligned 940. Aligning 940 the portioner and the dough bar entails placing them in near proximity to each other with the rod parallel or nearly parallel to a centerline of the dough bar and the cutters (of the cutter assemblies) of the portioner disposed to cut across the dough bar (see the dough bar 20, the portioner 360 and the rod 465, the cutter assembly 470, and the cutter 480 in FIGS. 3 and 4B, respectively). The portioner is articulated 945 across/through the dough bar, the cutters cutting through the dough bar at the intervals (spacing) by which the cutter assemblies are affixed to the rod, thereby dividing the dough bar into a plurality of identical or near-identical portions of dough. The portions are identical or nearly so because of (a) extrusion 930 through a fixed diameter/shape extrusion port at a uniform rate and (b) division (articulation 945 of the portioner) by a plurality of cutters set at equal intervals (spacing) along the rod of the portioner. The portioned dough is transferred 950 to another surface, such as, e.g., a baking sheet, a baking form, a storage container, a holding station, etc.

When the vat is empty or nearly empty, the plunger is removed 955. Removing 955 the plunger may be simply retracting the plunger upward and clear of the vat, or actual disassembly of the plunger from the dough portioning system, as appropriate. For example, the plunger may be retracted from the vat. A determination 960 may be made regarding reloading the vat with an additional load of the same dough. If “no” 970, the vat is not to be reloaded with another load of the same dough, the plunger and the equipment (the dough portioning system and associated components) is cleaned 975. If “yes” 965, the vat is to be reloaded with a load of the same dough, the next load of the same dough is loaded 920 into the vat. If necessary, the next load of dough is prepared 915 and then loaded 920 into the vat. If appropriate, prior to loading 920 the vat with another load of the same dough, the equipment may be cleaned 975. Likewise, if a different dough is to be portioned, the plunger is removed 965 and the equipment cleaned 975 prior to proceeding with the new dough.

It should be noted that, while the foregoing embodiments are discussed in the context of portioning a dough, the disclosure anticipates that any viscous material or viscous mixture may be portioned using the systems and methods herein disclosed.

### EXAMPLES

Some examples of embodiments of the present disclosure are now provided.

Example 1. A dough portioning system comprising: a vat to receive and hold dough to be portioned, the vat comprising an open top to receive the dough, the vat having a sidewall to contain the dough; an extrusion port through which the dough in the vat is extruded; a plunger configured to receive an input force to be driven to supply a compressive force on the dough in the vat to force the dough through the extrusion port; and a receiver assembly to receive a bar of dough formed as it is extruded from the extrusion port, the receiver assembly comprising: a receiver tray; and a receiver carriage to support the receiver tray and to extend or translate away from the extrusion port as the bar of dough is extruded to permit the receiver tray to receive or otherwise accommodate a length of the bar of dough.

Example 2. The system of example 1, wherein the plunger comprises: a head that is coextensive with the open top of the vat to engage the sidewall and that provides a dough engagement surface to supply the compressive force on the dough; and a shaft coupled to the head, the shaft to transfer force and to drive the head to supply the compressive force on the dough.

Example 3. The system of example 1, wherein a bottom of the vat tapers from the sidewall to the extrusion port.

Example 4. The system of example 3, wherein the plunger is tapered to correspond to the bottom of the vat.

Example 5. The system of example 1, further comprising a limit switch configured to be tripped when the receiver carriage extends a predetermined distance to halt the input force to the plunger and halt extrusion of the dough.

Example 6. The system of example 5, wherein the limit switch, when tripped, is further configured to trigger a slight retraction of the plunger to limit continued and undesired extrusion of the dough.

Example 7. The system of example 5, wherein the limit switch, when tripped, is further configured to trigger a cutting mechanism to separate the bar of dough (or dough log) from the dough at the extension port.

Example 8. The system of example 1, further comprising: a portioner to divide the bar of dough into a plurality of like size portions.

Example 9. The system of example 6, the portioner comprising: a rod; and a plurality of cutter assemblies configurably (or adjustably) positioned along the rod to cut the bar of dough into a plurality of like size portions as the portioner is pressed to the bar of dough.

Example 10. The system of example 9, wherein the portioner is further configured to facilitate simultaneous adjustment of the plurality of cutter assemblies to maintain equal spacing between each of the cutter assemblies of the plurality of adjacent cutter assemblies.

Example 11. The system of example 9, wherein the portioner comprises an adjustment mechanism to simultaneously adjust all of the plurality of cutter assemblies to maintain equal spacing between adjacent current assemblies.

Example 12. The system of example 11, wherein the adjustment mechanism comprises an eight-bar linkage.

Example 13. The system of example 1, wherein the sidewall of the vat forms a cylindrical shape, i.e., a dough containment space.

Example 14. The system of example 1, wherein the extrusion port is at a bottom of the vat.

Example 15. The system of example 1, wherein the extrusion port diameter is adjustable for changing a diameter of a bar of dough (or dough log) during extrusion.

Example 16. The system of example 1, further comprising a cutting mechanism at the extrusion port to cut the bar of dough to separate it from the dough remaining in the extrusion port and in the vat.

Example 17. The system of example 1, wherein the receiver carriage comprises a first tray guide to engage a corresponding second tray guide on the receiver tray to guide positioning of the tray relative to the receiver carriage.

Example 18. The system of example 17, wherein the first and second tray guides comprise magnets to receive the tray to a proper position.

Example 19. The system of example 17, wherein the first and second tray guides comprise a key-and-keyway to receive (and/or engage) the tray to a proper position.

Example 20. The system of example 1, wherein the receiver carriage comprises a cradle to receive the receiver tray.

Example 21. The system of example 1, wherein the receiver carriage comprises a base to receive and support the tray.

Example 22. The system of example 1, wherein the receiver carriage comprises one or more of: a roller bearing slide; a ball-bearing slide; and a key and keyway slide (e.g., sliding dovetail guide).

Example 23. The system of example 1, further comprising an actuation switch to initiate operation and movement of the plunger.

Example 24. The system of example 23, wherein the actuation switch comprises a finger-operable switch.

Example 25. The system of example 23, wherein the actuation switch comprises a foot pedal.

Example 26. A dough portioning system comprising: a cylindrical hopper to receive and hold dough to be portioned, the hopper comprising: an open top to receive the dough; a cylindrical sidewall to contain the dough, and an extrusion port at a bottom of the hopper through which the dough is forced during extrusion.

Example 27. The system of example 26, wherein the portioner comprises: a plurality of cutter assemblies similarly spaced to cut the bar of dough into a plurality of like size portions as the portioner is pressed to the bar of dough.

Example 28. The system of example 27, wherein the portioner comprises: a rod to support the plurality of cutter assemblies to be similarly spaced.

Example 29. The system of example 28, wherein the rod is indexed to facilitate uniformly orienting each cutter assembly of the plurality of cutter assemblies.

Example 30. The system of example 28, wherein each cutter assembly of the plurality of cutter assemblies comprises a wire disposed to pass through the bar of dough.

Example 31. The system of example 30, wherein each cutter assembly of the plurality of cutter assemblies further comprises a means of adjustably tensioning the wire.

Example 32. A dough portioning system comprising; a dough press comprising: a vat to receive and hold dough to be portioned, the vat having an open top to receive the dough, and having a sidewall to contain the dough; an extrusion port through which the dough from the vat is extruded; and a plunger configured to receive an input force to be driven to supply a compressive force on the dough in the vat to force the dough through the extrusion port; and a receiver assembly to receive a bar of the dough formed as it is extruded from the extrusion port, the receiver assembly comprising; a receiver tray; and a receiver carriage to support the receiver tray and to translate away from the extrusion port as the bar of dough is extruded to permit the receiver tray to receive a length of the bar of dough.

Example 33. A system to portion a viscous material, comprising a vat to receive and hold the viscous material; an extrusion (or dispenser) port through which the viscous material is extruded (or dispensed) from the vat; a plunger (or piston, press, impeller) or the like) to be driven, by transferring (e.g., translating) an input force, to supply a compressive force on the viscous material in the bat to force the viscous material through the extrusion port; a receiver assembly to receive a bar of the viscous material as the viscous material is extruded from the extrusion port, the receiver assembly comprising: a receiver tray; and a receiver carriage to support the receiver tray and to extend as the bar of viscous material is extruded to permit the receiver tray to receive the length of the bar of viscous material; and a portioner to divide the bar of viscous material into a plurality of like size portions, the portioner comprising; a rod; and a plurality of cutter assemblies configurably positioned along the rod to cut (e.g., divide, separate) the viscous material as the portioner is pressed to the bar of viscous material.

Example 34. The system of Example 33, wherein the rod is indexed to facilitate uniformly orienting each cutter assembly of the plurality of cutter assemblies.

Example 35. The system of Example 33, wherein each cutter assembly of the plurality of cutter assemblies comprises a wire disposed to pass through the bar of viscous material.

Example 36. The system of Example 35, wherein each cutter assembly of the plurality of cutter assemblies further comprises a means of adjustably tensioning the wire.

Example 37. The system of Example 33, wherein each cutter assembly of the plurality of cutter assemblies further comprises a blade-like member configured to pass through the bar of the viscous material.

Example 38. The system of Example 33, wherein the portioner is coupled to the receiver tray.

Example 39. The system of Example 33, wherein the portioner is coupled to a base portion of the system.

Example 40. The system of Example 33, wherein the portioner is detachable.

Example 41. The system of Example 33, wherein the extrusion (or dispenser) port is configurable to provide at least one of a preferred cross-sectional size and a preferred cross-sectional shape.

Example 42. A method to portion a viscous material, the method comprising: disposing the viscous material in a vat; applying a force to the viscous material within the vat to dispense a bar of the viscous material through an extrusion (e.g., dispenser) port to a receiver assembly; disposing a plurality of cutter assemblies along a rod of a portioner to define uniform portion sizes; and pressing (or translating, articulating, or the like) the plurality of cutter assemblies of the portioner through the bar of viscous material to divide the bat of viscous material into a plurality of like size portions.

Example 43. The method of Example 42, wherein the force is applied to the viscous material in the vat by operation of a plunger.

Example 44. The method of Example 42, wherein the extrusion port is configurable to at least one of a preferred cross-sectional size and a preferred cross-sectional shape.

Example 45. The method of Example 42, wherein each cutter assembly of the plurality of cutter assemblies comprises an adjustable wire under tension configured to pass through the bar of viscous material.

Example 46. The method of Example 42, wherein each cutter assembly of the plurality of cutter assemblies comprises a blade-like member configured to pass through the bar of viscous material.

It will be obvious to those having skill in the art that many changes may be made to the details of the above-described embodiments without departing from the underlying principles of the invention. The scope of the present invention should, therefore, be determined only by the following claims.

1. A dough portioning system comprising:
a vat to receive and hold dough to be portioned, the vat comprising an open top to receive the dough, the vat having a sidewall to contain the dough;
an extrusion port through which the dough in the vat is extruded;
a plunger configured to receive an input force to be driven to supply a compressive force on the dough in the vat to force the dough through the extrusion port; and
a receiver assembly to receive a bar of dough formed as it is extruded from the extrusion port, the receiver assembly comprising:
a receiver tray; and
a receiver carriage to support the receiver tray and to extend away from the extrusion port as the bar of dough is extruded to permit the receiver tray to receive a length of the bar of dough.

2. The system of claim 1, wherein the plunger comprises:
a head that is coextensive with the open top of the vat to engage the sidewall and that provides a dough engagement surface to supply the compressive force on the dough; and
a shaft coupled to the head, the shaft to drive the head to supply the compressive force on the dough.

3. The system of claim 1, wherein a bottom of the vat tapers from the sidewall to the extrusion port.

4. The system of claim 3, wherein the plunger is tapered to correspond to the bottom of the vat.

5. The system of claim 1, further comprising a limit switch configured to be tripped when the receiver carriage extends a predetermined distance to halt the input force to the plunger and halt extrusion of the dough.

6. The system of claim 1, further comprising:
a portioner to divide the bar of dough into a plurality of like size portions.

7. The system of claim 6, the portioner comprising:
a rod; and
a plurality of cutter assemblies configurably positioned along the rod to cut the bar of dough into a plurality of like size portions as the portioner is pressed to the bar of dough.

8. The system of claim 1, wherein the sidewall of the vat forms a cylindrical shape.

9. The system of claim 1, wherein the extrusion port is at a bottom of the vat.

10. The system of claim 1, wherein a diameter of the extrusion port is adjustable for changing a diameter of a bar of dough during extrusion.

11. The system of claim 1, further comprising a cutting mechanism at the extrusion port to cut the bar of dough to separate it from the dough remaining in the extrusion port and in the vat.

12. The system of claim 1, wherein the receiver carriage comprises a first tray guide to engage a corresponding second tray guide on the receiver tray to guide positioning of the tray relative to the receiver carriage.

13. The system of claim 1, wherein the receiver carriage comprises one or more of:
a roller bearing slide;
a ball-bearing slide; and
a key and keyway slide.

14. The system of claim 1, further comprising an actuation switch to initiate operation and movement of the plunger.

15. A dough portioning system comprising:
a cylindrical hopper to receive and hold dough to be portioned, the hopper comprising:
an open top to receive the dough;
a cylindrical sidewall to contain the dough, and
an extrusion port at a bottom of the hopper through which the dough is forced during extrusion.

16. The system of claim 15, wherein the portioner comprises:
a plurality of cutter assemblies similarly spaced to cut the bar of dough into a plurality of like size portions as the portioner is pressed to the bar of dough.

17. The system of claim 16, wherein the portioner comprises:
a rod to support the plurality of cutter assemblies to be similarly spaced.

18. The system of claim 17, wherein the rod is indexed to facilitate uniformly orienting each cutter assembly of the plurality of cutter assemblies.

19. The system of claim 17, wherein each cutter assembly of the plurality of cutter assemblies comprises a wire disposed to pass through the bar of dough.

20. The system of claim 19, wherein each cutter assembly of the plurality of cutter assemblies further comprises a means of adjustably tensioning the wire.
